(19) United States
(12) Patent Application Publication
(10) Pub. No.: US 2005/0040925 A1
(43) Pub. Date: Feb. 24, 2005

(54) Circuit breaker

(76) Inventor: Albert Huang, Taipei (TW)

Correspondence Address: DELLETT AND WALTERS, P. O. BOX 2786, PORTLAND, OR, 97208-2786, US

(21) Appl. No.: 10/646,445

(22) Filed: Aug. 21, 2003

(51) Int. Cl. H01H 71/16

(52) U.S. Cl. 337/66

(57) ABSTRACT

A circuit breaker includes a body with a chamber defined therein. A button is pivotally mounted at an upper side of the chamber. Two terminals are provided in the chamber and extend out of from a bottom of the body. The first terminal has a first node formed at an upper end thereof. The second terminal has a bimetallic strip extending above the first terminal, and a second node is formed at a distal end of the bimetallic strip and electrically connected with the first node in a switched-on status. A key is provided in the body and between the terminals and beneath the bimetallic strip. The key has a lug formed on an upper surface of the key and abuts the bimetallic strip in the normal status. When the circuit breaker experiences an excessively high consumption of electricity by devices connected thereto, the bimetallic strip can be deformed to terminate the circuit.

### BACKGROUND OF THE INVENTION

1. Field of the Invention

The present invention is related to a circuit breaker, and more particularly to a circuit breaker which can automatically terminate an electricity supply when an excessive amount of power is drawn.

2. Description of Related Art

For protecting electrical equipment, a circuit breaker is generally used to terminate a supply of electricity when a device or devices connected to the supply start to draw an excessive amount of electricity.

A conventional circuit breaker is provided with two terminals. A bimetallic strip with a movable node is formed on one of the terminals. In a normal state, the movable node is electrically connected with an immovable node formed on the other terminal. In an over-current state, the bimetallic strip becomes hot and deforms and the movable node is disconnected from the immovable node to switch off the circuit.

However, the bimetallic strip will not deform to disconnect the nodes unless its temperature reaches a critical value, so the sensitivity of the bimetallic strip may not be enough under certain situations where overloading occurs but the temperature involved is not high enough to trigger the termination of the electricity supply.

Therefore, the invention provides a circuit breaker to mitigate and/or obviate the aforementioned problems.

### SUMMARY OF THE INVENTION

The main objective of the invention is to provide a circuit breaker which has a high sensitivity.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a circuit breaker in accordance with the invention;

FIG. 2 is an exploded perspective view of the circuit breaker in FIG. 1;

FIG. 3 is a cross sectional view of the circuit breaker in a switched-off status; and

FIG. 4 is a cross sectional view of the circuit breaker in a switched-on status.

### DETAILED DESCRIPTION OF THE PREFERRED EMBODIMENT

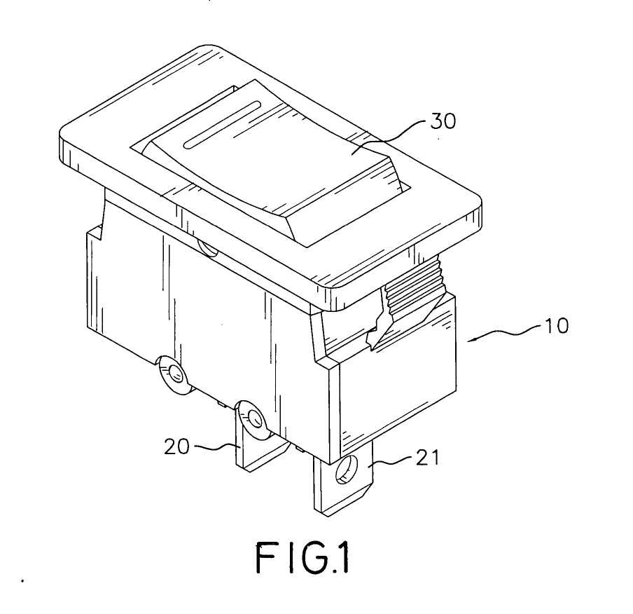

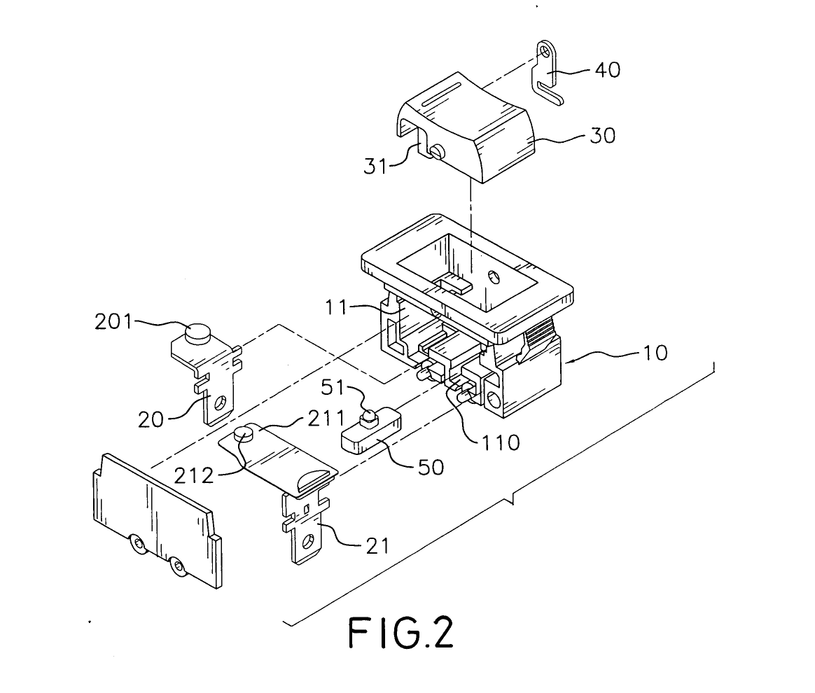

Referring to FIGS. 1-2, a circuit breaker in accordance with the invention has a body (10) with a chamber (11) defined therein. A button (30) is pivotally mounted at an upper side of the chamber (11). Two terminals (20, 21) are provided in the chamber (11) and extend from a lower side of the chamber (11). The first terminal (20) has an immovable node (201) formed at an upper end thereof, and the second terminal (21) has a bimetallic strip (211) formed at an upper end thereof and extending above the first terminal (20). A movable node (212) is formed at a distal end of the bimetallic strip (211) and aligned with the immovable node (201). In a normal status, the movable node (212) is electrically connected with the immovable node (201).

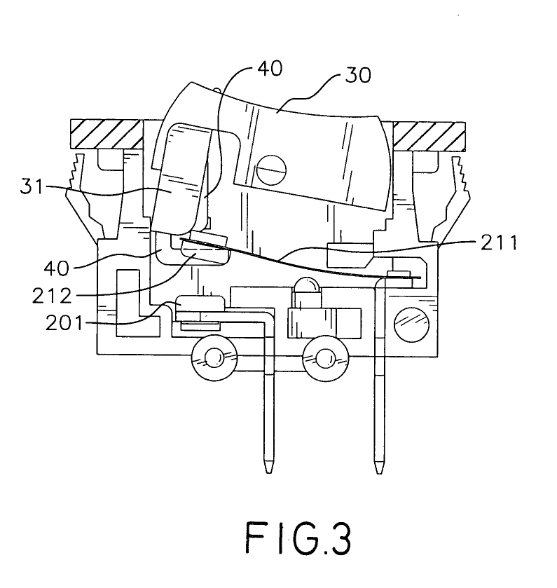

A tab (31) is formed at a bottom side of the button (30) and near the first terminal (20). A hook (40) installed on the tab (31) is attached to the distal end of the bimetallic strip (211), as shown in FIG. 3. A user can press the button (30) to pull upwards the bimetallic strip (211) by the hook (40) to manually terminate the circuit.

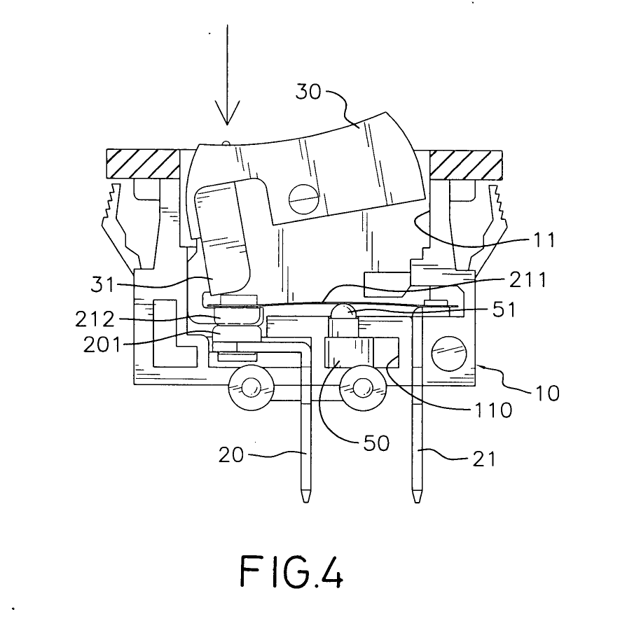

Referring back to FIG. 2, the body (10) further has a channel (110) defined between the terminals (20, 21) and in communication with the chamber (11). A key (50) is received in the channel (110) and has a lug (51) formed on an upper surface thereof and beneath the bimetallic strip (211). When the circuit breaker is in the switched-on status, as shown in FIG. 4, the bimetallic strip (211) is slightly pushed upwards by the lug (51).

When the circuit is under an over-current situation, the bimetallic strip (211) becomes hot and deforms with a tendency to disconnect the movable node (212) from the immovable node (201). Because the lug (51) provides an additional force to push the bimetallic strip (211) upwards, the bimetallic strip (211) is disconnected from the first terminal (20) to terminate the circuit before its critical temperature is reached. Therefore, the circuit breaker has a high sensitivity to provide a further protection for an electrical device.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A circuit breaker comprising:
a body having a chamber defined therein;
a button pivotally mounted at an upper side of the chamber;
two terminals provided in the chamber and extending out of from a bottom of the body, wherein a first of the terminals has a first node formed at an upper end thereof, and a second of the terminals has a bimetallic strip extending above the first terminal and a second node formed at a distal end of the bimetallic strip and electrically connected with the first node in a normal status; and
a key provided in the body and between the terminals and beneath the bimetallic strip, the key having a lug formed on an upper surface of the key and abutting the bimetallic strip in the normal status.

2. The circuit breaker as claimed in claim 1, wherein the button further has a tab formed at a bottom side thereof and near the first terminal, and a hook installed on the tab is attached to the distal end of the bimetallic strip.

3. The circuit breaker as claimed in claim 1, wherein the body further has a channel in communication with the chamber, and the key is received in the channel.
